(19) United States
(12) Patent Application Publication
(10) Pub. No.: US 2026/0218598 A1
(43) Pub. Date: Jul. 30, 2026

(54) BOREHOLE MONITORING AND INTERPRETATION USING AI

(71) Applicant: Hallburton Energy Services, Inc., Houston, TX (US)

(72) Inventors: Edgar Gutierrez Gonzalez, Houston, TX (US); Jeremy Combs, Houston, TX (US); David ANTHONY, Houston, TX (US)

(21) Appl. No.: 19/039,293

(22) Filed: Jan. 28, 2025

(51) Int. Cl. E21B 44/00; E21B 7/04; G01V 20/00; G08B 21/18

(52) U.S. Cl. CPC E21B 44/00; E21B 7/04; G01V 20/00; G08B 21/182; E21B 2200/20

(57) ABSTRACT

Typical borehole monitoring systems produce a visual component that can be used by a user to monitor borehole operations. It can be difficult for a user to monitor more than one monitoring system, where different skills are used, different output formats can be used, and where users can be distracted or miss an interpretation. A borehole operation analyzer can use as inputs the other borehole monitoring systems output visuals (such as images, graphs, charts, spreadsheets, or other types of visuals) to produce an improved monitoring and generate an analysis using two or more monitoring systems. The processes can generate messages, alerts, warnings, recommendations, or directions to other borehole systems using specified thresholds. Users can act using the results, other borehole systems can use the results as inputs into their processing systems, or borehole systems can be directed to take action using the results from the analysis,

### TECHNICAL FIELD

This application is directed, in general, to monitoring drilling operation data and, more specifically, to using artificial intelligence to assist in analyzing the drilling operation data.

### BACKGROUND

The engineers and operations personnel monitor many operational systems at a borehole or reservoir. Expertise by the personnel is needed in each area being monitored so appropriate analysis can be conducted. Personnel can be tired, suffer malaise, or may not be an expert in a certain operational area. This can result in analysis and interpretations that are not as optimal as the operations team desires.

### SUMMARY

In one aspect, a method is disclosed. In one embodiment, the method includes (1) receiving input parameters and one or more outputs from borehole monitoring systems monitoring a borehole operation at a borehole, wherein the one or more outputs are information graphics generated from data collected from sensors located at a surface location of the borehole or from sensors located downhole the borehole, (2) analyzing the one or more outputs using a machine learning system to initialize or refine a borehole operation monitor model (3) applying training labels to a result of the analyzing, wherein the training labels correspond to analyzed events from the one or more outputs, (4) validating the training labels by a user, and (5) updating and storing the borehole operation monitor model for use at a borehole site to monitor borehole operations.

In a second aspect, a second method is disclosed. In one embodiment the second method includes (1) receiving input parameters and one or more outputs from borehole monitoring systems, wherein the one or more outputs are information graphics and the borehole monitoring systems produce the one or more outputs from data collected from one or more sensors located downhole a borehole or at a surface of the borehole while the borehole is undergoing a borehole operation, (2) analyzing the one or more outputs using a machine learning system to execute a previously trained borehole operation monitor model to determine parameters for one or more events occurring during the borehole operation, (3) generating a result from the analyzing, wherein the result is one of a message, a warning, an alert, or a recommendation, and the parameters of the one or more events, and (4) communicating the result to a user or a borehole system.

In a third aspect, a borehole operation monitor model system is disclosed. In one embodiment, the borehole operation monitor model system includes (1) a data transceiver, capable of receiving input parameters and outputs from at least one information graphic from one or more borehole monitoring systems, wherein the borehole monitoring systems receive input from one or more sensors located at a surface of a borehole or located downhole the borehole, (2) a borehole operation monitor model, capable of communicating with the data transceiver and analyzing the outputs from the at least one information graphic for one or more events of a borehole operation being performed at the borehole, and (3) a borehole operation analyzer, capable of communicating with the borehole operation monitor model and determining one or more parameters for the one or more events including a probability of occurrence over a specified time interval, and generating a result to be communicated, wherein the result is a message, warning, alert, or recommendation.

In a fourth aspect, a non-transitory computer program product having a series of operating instructions stored on a non-transitory computer-readable medium that directs operations is disclosed. In one embodiment, the operations include (1) receiving input parameters and one or more outputs from borehole monitoring systems, wherein the one or more outputs are information graphics and the borehole monitoring systems produce the one or more outputs from data collected from one or more sensors located downhole a borehole or at a surface of the borehole while the borehole is undergoing a borehole operation, (2) analyzing the one or more outputs using a machine learning system to execute a previously trained borehole operation monitor model to determine parameters for one or more events occurring during the borehole operation, (3) generating a result from the analyzing, wherein the result is one of a message, a warning, an alert, or a recommendation, and parameters of the one or more events, and (4) communicating the result to a user or a borehole system

### BRIEF DESCRIPTION

Reference is now made to the following descriptions taken in conjunction with the accompanying drawings, in which:

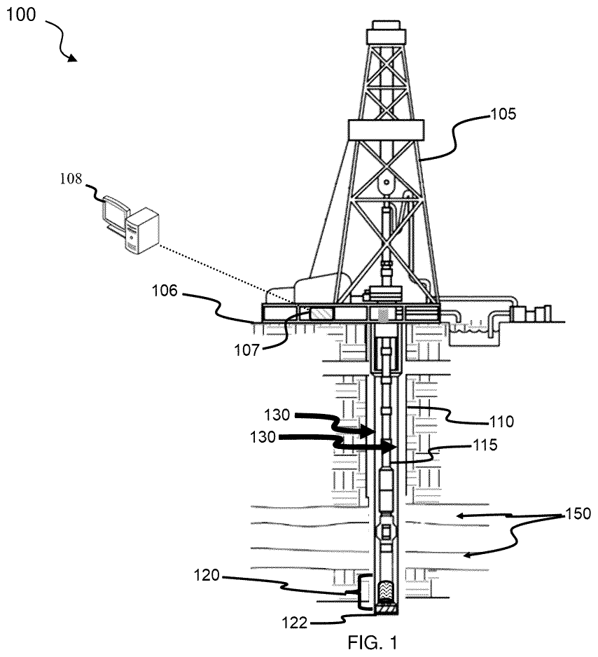

FIG. 1 is an illustration of a diagram of an example drilling system;

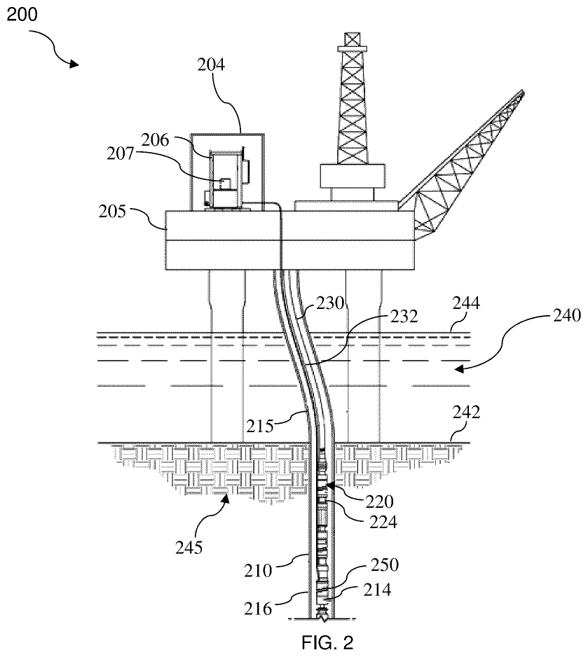

FIG. 2 is an illustration of a diagram of an example offshore well system;

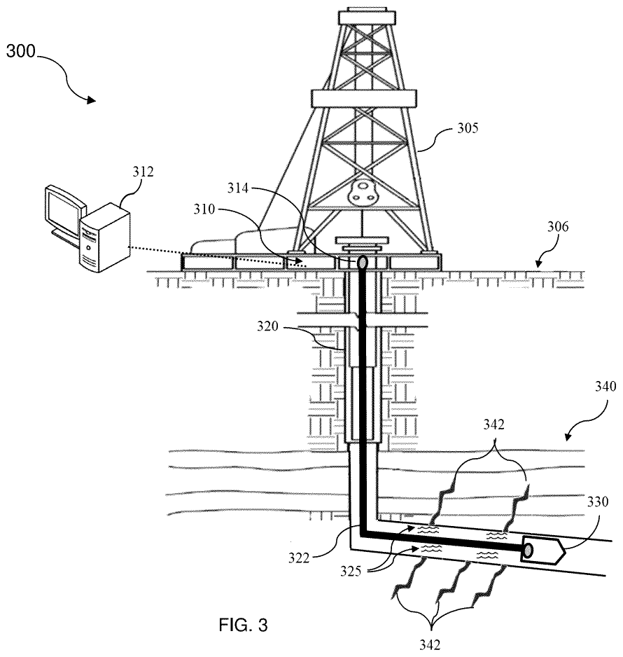

FIG. 3 is an illustration of a diagram of an example hydraulic fracturing well system;

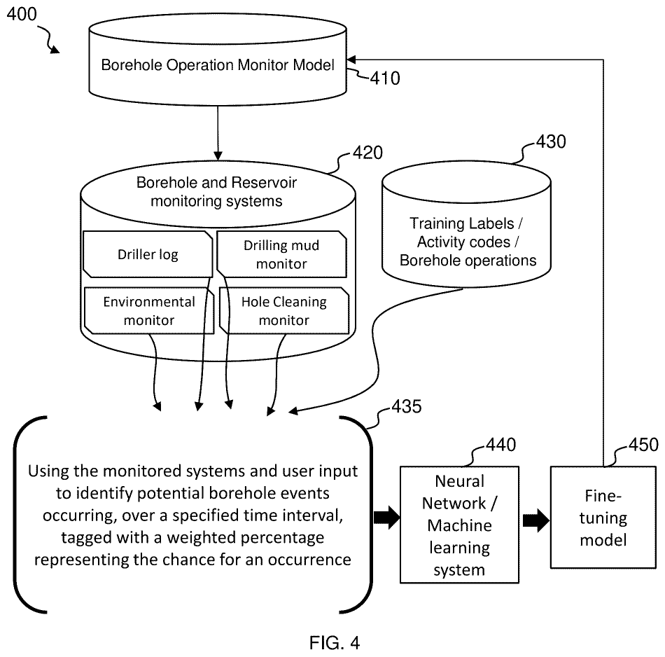

FIG. 4 is an illustration of a diagram of an example training flow;

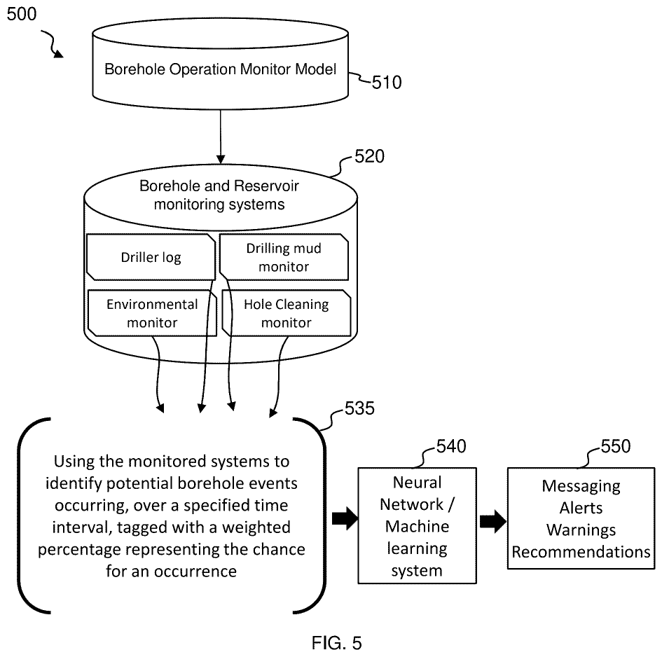

FIG. 5 is an illustration of a diagram of an example analyzation flow;

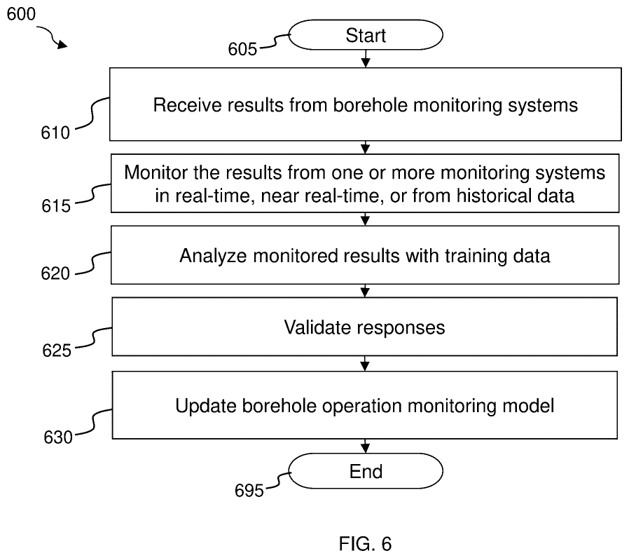

FIG. 6 is an illustration of a flow diagram of an example method to train a borehole operation monitor model;

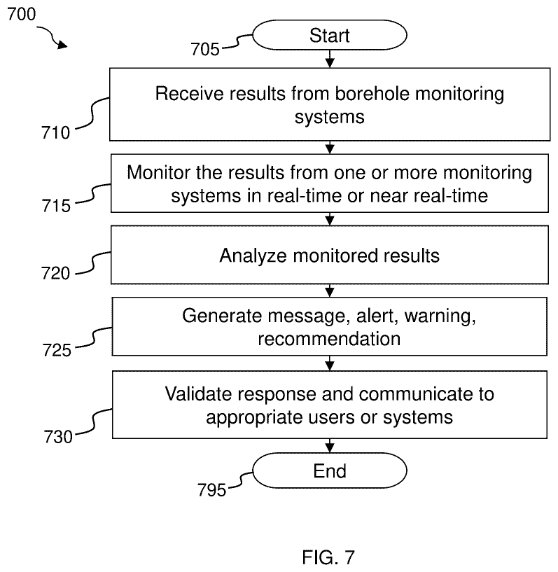

FIG. 7 is an illustration of a flow diagram of an example method utilizing a borehole operation monitor model;

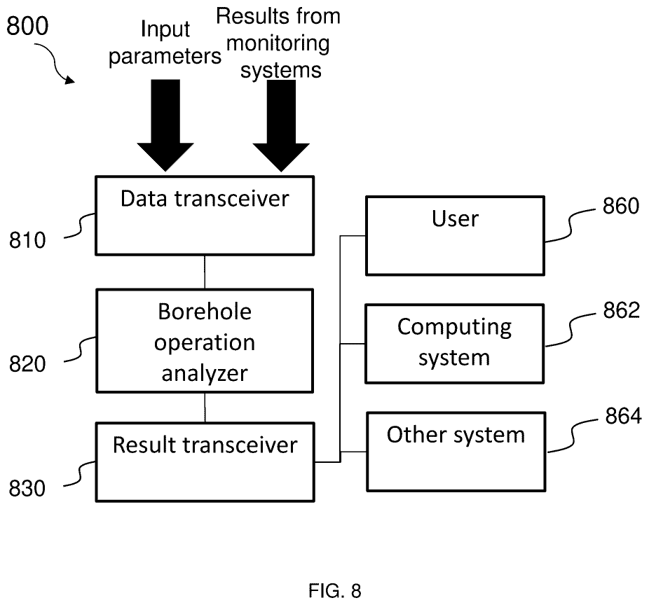

FIG. 8 is an illustration of a block diagram of an example borehole operation monitor model system;

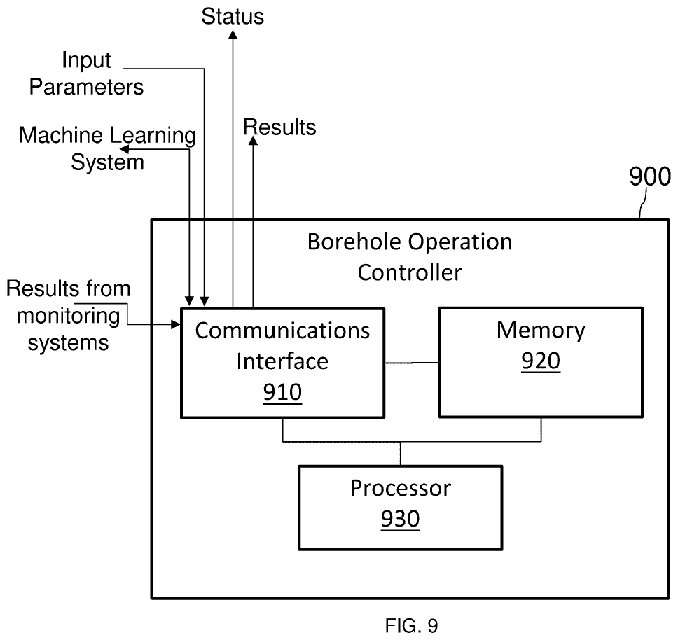

FIG. 9 is an illustration of a block diagram of an example borehole operation monitor model controller according to the principles of the disclosure; and

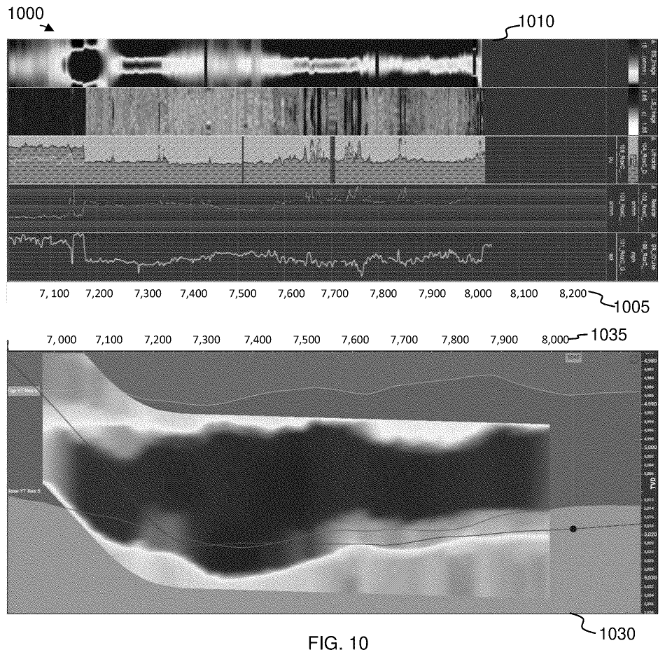

FIG. 10 is an illustration of a diagram of an example analysis using two example borehole operation monitors.

### DETAILED DESCRIPTION

In developing a borehole, the engineers and operators at the borehole site can monitor one or more borehole operation parameters. Typically, there are sensors located with surface equipment and located downhole. These sensors can communicate various data elements to one or more surface controllers. The engineers and operators (e.g., users) can use one or more tools to analyze the sensor data, such as reviewing the collected data or reviewing the data after being transformed into a visual format. The borehole can be for hydrocarbon production purposes, scientific purposes, or other types of borehole activities.

The borehole can be located at a location around the globe, in a country's borders, or a body of water. The borehole can be part of a larger reservoir such as with other boreholes located within the reservoir area. The users at the borehole location can have expertise in one or more borehole operational areas. There may be operational areas in which they do not have expertise. In these scenarios, additional users can be tasked to monitor the borehole operations thereby increasing costs. Users can speak various languages and may not be able to communicate using a language understood by the other workers at the borehole site.

Borehole operations are typically monitored by more than one monitoring system. The problems and issues mentioned above increase as users monitor multiple monitoring systems. Each monitoring system can produce its results differently from other monitoring systems. For example, a system could use one or more of a vertical graph, a horizontal graph, a spreadsheet, a chart, or other types of visualizations (e.g., information graphic outputs), such as two-dimensional (2D) and three-dimensional (3D) representations (e.g., 2D models and 3D models). Users can have difficulty switching between these different environments regularly, where their focus is continuously changing across the different monitoring systems.

This disclosure presents processes to automate the analysis of various borehole operations in such a way as to reduce the number of users to perform the monitoring operation. Automated monitoring can result in improved accuracy compared to users performing the analysis. For example, a lack of subject matter expertise by a user can be overcome by an automated monitoring system. Tiredness, bias, and distraction can be avoided as well by an automated system.

Other solutions in this area can consume the data that has been collected by the sensors, process the data, and then produce a result analyzing the collected data. To implement these solutions, access to the underlying sensor data is used to generate the results. This limitation limits these other solutions to having access to the sensor data, that various borehole systems need to be modified to support the analysis system, and incorporating third-party products and solutions can be difficult since the third party can have black box functionality.

To overcome these challenges, this disclosure describes a process to train an artificial intelligence (AI) system on the output of other systems and processes, and then use the trained AI to perform the monitoring of the borehole operations. For example, a conventional system can receive sensor data, transform the sensor data, apply filtering, and produce a result such as a visual graph showing the data plotted over time. In some aspects, the data plotted can be referenced to time, true vertical depth, measured borehole depth, or other types of borehole reference parameters.

In some aspects, the processes can monitor the resultant graph and produce alerts, warnings, recommendations, or other messaging for the users to address potential issues or events with the borehole operation. In some aspects, the processes can monitor the resultant graph and communicate identified potential issues or events with the borehole operation to other borehole systems, directing them to correct the current operations to reduce the potential for the event to occur. For example, the process can communicate that casing wear at a downhole borehole location is exceeding expectations and so the weight-on-bit (WOB) or rotations per minute (RPM) of the drill string should be modified to reduce the wear of the casing at that location.

The AI monitoring (e.g., using a borehole operation analyzer) can analyze information from one or more conventional monitoring systems to provide an improved comprehensive analysis of the borehole operations. The processes can correlate multiple images, displays, and visualizations from various monitoring systems. For example, the described processes can analyze results from driller displays, log plots, geosteering quality control (QC) plots, and survey reports to determine an analysis result for the current borehole operation. Users receiving the analysis result from the disclosed processes can act using information from across all monitored systems while reducing the burden of task switching between disparate monitoring systems. The response time to a change in a potential event or issue at the borehole can be reduced by using the processes.

In some aspects, the borehole operation analyzer can monitor the borehole monitor systems from more than one borehole, such as two or boreholes in a reservoir. Some events, such as tracking the flow of a subterranean reservoir, could incorporate monitoring the monitors from two or more boreholes. The disclosed processes can include the outputs from across the borehole monitoring systems to produce its analysis results. A system executing the disclosed methods can perform monitoring on two or more boreholes and provide the results and messaging separately for each borehole during the same execution time interval. In some aspects, the system can use a different borehole operation monitor model for each of the boreholes being monitored.

In some aspects, the borehole operation analyzer can be a machine learning system, a deep neural network learning system, or other types of learning systems capable of performing operations to analyze the results of borehole operation monitoring systems. In some aspects, the borehole operation monitor model can be located on a computing system, process, borehole system, or borehole controller. In some aspects, the borehole operation monitor model can be located on the same system as one or more of the borehole operation monitoring systems. In some aspects, training of the borehole operation monitor model can occur on the borehole operation analyzer, e.g., an operations processor. In some aspects, training of the borehole operation monitor model can occur on a system separate from the borehole operation analyzer.

In some aspects, the output of the borehole operation analyzer can be used as an input into other machine learning systems, such as learning systems used to generate directions, e.g., instructions, for borehole operations. In some aspects, the directions can be a change in drilling direction, WOB, RPM, drilling mud composition, or HF fluid composition. In some aspects, the output of the borehole operation analyzer can be used as input to make decisions on future operations at the borehole, such as directing the need for different equipment, replacement equipment, or supplies, or adjusting drilling operations, extraction operations, intercept operations, or other borehole operations. For example, adjusting the borehole operation can be one or more of directing the use of different equipment or ordering replacement equipment.

Turning now to the figures, FIG. 1 is an illustration of a diagram of an example drilling system 100 drilling along a planned borehole path, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105, a well site controller 107, and a computing system 108. Well site controller 107 includes a processor and a memory and is configured to direct the operation of drilling system 100. Derrick 105 is located at a surface 106.

Extending below derrick 105 is a borehole 110 with downhole tools 120 at the end of a drill string 115. Downhole tools 120 can include various downhole tools, such as a formation tester or a bottom-hole assembly (BHA). Downhole tools 120 can include a seismic tool or an ultra-deep seismic tool. At the bottom of downhole tools 120 is a drilling bit 122. Other components of downhole tools 120 can be present, such as a local power supply (e.g., generators, batteries, or capacitors), telemetry systems, sensors, transceivers, and control systems. Borehole 110 is surrounded by subterranean formation 150.

Well site controller 107 or computing system 108 which can be communicatively coupled to well site controller 107, can be utilized to communicate with downhole tools 120, such as sending and receiving acoustic data, seismic data, telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, parameters, measurements, and other information by various conventional means, now known or later developed, with computing system 108 or well site controller 107. Well site controller 107 or computing system 108 can communicate with downhole tools 120 using conventional means, now known or later developed, to direct operations of downhole tools 120, e.g., geo-steering operations. Casing 130 can act as a barrier between subterranean formation 150 and the fluids and material internal to borehole 110, as well as drill string 115.

In some aspects, a borehole operation analyzer can receive input from the output of other borehole monitoring systems, such as visualizations, spreadsheets, or other user-friendly presentations of the results, where the other borehole monitoring systems receive their inputs from sensors, equipment, or tools located at or near drilling system 100. In some aspects, the borehole operation analyzer can be part of a system or controller, such as borehole operation monitor model system 800 of FIG. 8 or borehole operation monitor model controller 900 of FIG. 9. In some aspects, the borehole operation analyzer can be part of well site controller 107 or computing system 108. In some aspects, the borehole operation analyzer can be part of an edge computing system, a cloud environment, a data center environment, a corporate environment, a laboratory environment, or be implemented on a server, smartphone, laptop, or other type of computing system located proximate drilling system 100 or located a distance away.

In some aspects, the resulting output from the borehole operation analyzer can be used to direct operations of drilling system 100, such as to update or modify operations of a drilling controller, for example, modifying the planned borehole path, the drilling parameters used by a downhole drilling assembly (e.g., WOB, RPM, rate of penetration (ROP), or other drilling parameters) change the composition of drilling mud or hydraulic fracturing fluid, modify pump parameters (surface pressure, downhole pressure, temperature, composition, or other fluid parameters), prepare repairs of the casing, ensure that the proper supplies and parts are ordered, or other types of updates of drilling system 100.

In some aspects, the resulting output from the borehole operation analyzer can be used to communicate a message, an alert, a warning, or a recommendation to be reviewed by a user, where the user can initiate or approve further action by the drilling operation systems. A message can be a report of what is happening or what is expected downhole the borehole. An alert can be a priority that should be addressed by a user, for example, a sudden drop in fluid pressure can be addressed by a user. A warning can be an indication to a user that a borehole event may occur, for example, providing an estimation of the probability of an event over a subsequent time interval. A recommendation can be suggested modifications to drilling operations, such as one or more suggestions to alleviate the alert or warning situation, or a recommendation to improve the efficiency of drilling operations.

FIG. 2 is an illustration of a diagram of an example offshore well system 200 with an electric submersible pump (ESP) assembly 220. ESP assembly 220 is placed downhole in a borehole 210 below a body of water 240, such as an ocean or sea. Borehole 210, protected by casing, screens, or other structures, is surrounded by subterranean formation 245. ESP assembly 220 can be used for onshore operations. ESP assembly 220 includes a well controller 207 (for example, to act as a speed and communications controller of ESP assembly 220), an ESP motor 214 (e.g., the constant speed power mechanism), and an ESP pump 224 (e.g., the fluid pump).

Well controller 207 may be placed in a cabinet 206 inside a control room 204 on an offshore platform 205, such as an oil rig, above water surface 244. Well controller 207 may be configured to adjust the operations of ESP motor 214 to improve well productivity. In the illustrated aspect, ESP motor 214 is a two-pole, three-phase squirrel cage induction motor that operates to turn ESP pump 224. ESP motor 214 is located near the bottom of ESP assembly 220, just above downhole sensors within borehole 210. An energy/communication cable 230 extends from well controller 207 to ESP motor 214. A tubular 232 fluidly couples equipment located on offshore platform 205 and ESP pump 224.

In some aspects, ESP pump 224 can be a horizontal surface pump, a progressive cavity pump, a subsurface compressor system, or an electric submersible progressive cavity pump. A motor seal section and intake section may extend between ESP motor 214 and ESP pump 224. A riser 215 separates ESP assembly 220 from water 240 until sub-surface 242 is encountered, and a casing 216 can separate borehole 210 from subterranean formation 245 at and below sub-surface 242. Perforations in casing 216 can allow the fluid of interest from subterranean formation 245 to enter borehole 210. Located between ESP motor 214 and ESP pump 224 is a variable torque converter 250.

In some aspects, the borehole operation analyzer can be part of well controller 207. In some aspects, the borehole operation analyzer can be part of a computing system located at offshore well system 200 or located a distance away. In some aspects, the output of the borehole operation analyzer can be used as an input into other machine learning systems, for example, to communicate an alert or warning where the other machine learning systems can then generate a recommendation for a user or direct corrective action to one or more borehole systems. In some aspects, the output of the borehole operation analyzer can be used as input to make decisions on future operations at offshore well system 200, such as directing the need for different equipment, replacement equipment, or adjusting drilling operations.

FIG. 3 is an illustration of a diagram of a hydraulic fracturing (HF) well system 300, which can be a well site where HF operations are occurring through the implementation of a HF treatment stage plan. HF well system 300 demonstrates a nearly horizontal wellbore undergoing a fracturing operation.

HF well system 300 includes a surface well equipment 305 located at a surface 306, a well site control equipment 310, and an HF pump system 314 (e.g., a fluid pump system). In some aspects, well site control equipment 310 is communicatively connected to a separate computing system 312, for example, a separate server, data center, cloud service, tablet, laptop, smartphone, or other types of computing systems. Computing system 312 can be located proximate to well site control equipment 310 or located a distance from well site control equipment 310.

Extending below surface 306 from surface well equipment 305 is a wellbore 320. Wellbore 320 can have zero or more cased sections and a bottom section that is uncased. Inserted into the wellbore 320 is a fluid pipe 322. The bottom portion of fluid pipe 322 has the capability of releasing downhole material 325, such as carrier fluid with diverter material, from fluid pipe 322 to subterranean formations 340. The release of downhole material 325 can be by perforations in fluid pipe 322, by valves placed along fluid pipe 322, or by other release means. At the end of fluid pipe 322 is a bottom hole assembly (BHA) 330, which can be one or more downhole tools or an end cap assembly.

In HF well system 300, fluid pipe 322 is releasing downhole material 325 into subterranean formation 340 at a determined HF fluid pressure and HF fluid flow rate. Downhole material 325 is being absorbed by, e.g., entering or flowing into, several fractures 342. Well site control equipment 310 can include a well site parameter collector that can collect sensor data from one or more fluid sensors proximate to the well site, located at a surface location, such as part of HF pump system 314, and located downhole within wellbore 320, such as a downhole HF fluid pressure gauge and a distributed acoustic sensor. This sensor data can be received as input parameters to well site control equipment 310.

Well site control equipment 310 and computing system 312 can direct HF pump system 314 to adjust the torque delivered to the pump to control the HF fluid pressure and the HF fluid flow rate. In some aspects, well site control equipment 310 can include a borehole operation analyzer to analyze the outputs of other borehole monitoring systems. The output of the borehole operation analyzer can be used by other machine learning systems to anticipate events that would need a change of the delivered torque of a pump system using the input parameters, such as when downhole conditions change, the composition of the fluid changes, or gears in a connected transmission pump system have been instructed to change by well site control equipment 310.

In some aspects, the borehole operation analyzer can be part of well site control equipment 310. In some aspects, the borehole operation analyzer can be part of computing system 312, or located a distance away. In some aspects, the output of the borehole operation analyzer can be used as an input into other machine learning systems. In some aspects, the output of the borehole operation analyzer can be used as input to make decisions on future operations at HF well system 300, such as directing the need for different equipment, replacement equipment, or adjusting fracturing operations.

While FIGS. 1 and 3 depict onshore operations, those skilled in the art will understand that the disclosure is equally well suited for use in offshore operations, such as shown in FIG. 2. FIGS. 1-3 depict specific borehole configurations, and those skilled in the art will understand that the disclosure is equally well suited for use in boreholes having other orientations including vertical boreholes, horizontal boreholes, slanted boreholes, multilateral boreholes, and other borehole types. FIGS. 1-3 depict certain types of pumping operations, and those skilled in the art will understand that the disclosure can apply to drilling operations, production operations, intercept operations, relief well operations, completion operations, hydraulic fracturing operations, measure while drilling operations, logging while drilling operations, seismic while drilling operations, completed borehole operations, production testing operations, slickline or wireline operations, coiled tubing string remediation, seismic profiling, and other types of borehole operations while not departing from the scope of the disclosure. For example, the disclosure can apply to a drilling borehole system, an injection borehole system, a hydraulic fracturing borehole system, a production borehole system, or a completed borehole system. In some aspects, the borehole operations can produce oil or gas products, or for scientific purposes, research, testing, or other non-hydrocarbon-related purposes.

FIG. 4 is an illustration of a diagram of an example training flow 400. Training flow 400 can be used to train a borehole operation monitor model using one or more types of machine learning systems, such as deep learning networks, neural networks, and other types of machine learning systems. A data store 410 can receive the initialized or partially trained models. The models can be initialized or partially trained using visualizations stored from previous sensor readings. The models can be initialized using large language models (LLMs) that have processed written information, such as daily drilling reports.

In a process 420, the received models can apply output from borehole monitoring systems or reservoir monitoring systems, where the output is a user visual (e.g., an information graphic), such as graphs, charts, 2D visualizations, 3D visualizations, spreadsheets, or other visuals. For example, drilling logs, drilling mud monitors, environmental monitors, hole cleaning monitors, hydraulic fracturing fluid monitors, drilling assembly monitors, casing monitors, pump monitors, derrick or rig monitors, or other types of monitor outputs can be used. In some aspects, the information graphic can be a visual representation of one or more of a well log curve, a plot, a drilling information graphic, a geology model mapping, or a resistivity inversion image. Process 420 shows four types of activities; there can be one or more types of activities used in the training, the limit is limited by the number of available monitor outputs. What is shown is for demonstration purposes.

Data store 430 stores training labels that can be used. The training labels can be borehole events, subterranean formation characteristics, equipment thresholds or failure points, or other types of training labels. For example, a bed boundary, oil-water boundary, a threshold for casing failure, or other types of training labels can be used to identify the events, warning conditions, or characteristics represented by the borehole monitoring system outputs. The borehole operation monitor model can be used to process the borehole and reservoir-specific monitoring outputs with the codes from data store 430 in a process 440. A demonstration of the matching is shown in bracket 435. Bracket 435 demonstrates that one or more visualization outputs from the monitoring system can be used to identify a potential borehole event, such as changing bed boundaries, drilling mud exceeding a specified threshold, or the increasing need for a hole-cleaning operation. These events can be associated with a threshold provided in input parameters to the system which indicates warning, alert, and critical levels for the event, for example, a hole cleaning operation can be used at a probability exceeding x %. The events can be tagged with a probability percentage of occurring over a specified time interval, where the time interval can be specified in the input parameters to the system. In this example, the result of the model training can indicate that given the input from the monitoring systems, there is an x % chance that the specified event will occur over y time interval.

The output of process 440 is a refined borehole operation monitor model. Process 420, data store 430, and process 440 can be part of the same machine learning system, where process 420 concentrates on analyzing the monitoring systems' output and process 440 concentrates on matching training labels to the output of process 420. In a process 450, the refined model can be processed and stored for future utilization. The training process can be iterative so that as more monitoring outputs are analyzed, the borehole operation monitor model can be continually refined and improved.

FIG. 5 is an illustration of a diagram of an example analysis flow 500. Analysis flow 500 builds on FIG. 4 by using the refined borehole operation monitor model that was trained using training flow 400. The received borehole or reservoir monitoring system outputs can be processed through the trained borehole operation monitor model to generate results and communicate those results through messages, alerts, warnings, recommendations, or directions to other borehole systems. In some aspects, thresholds or warning, alert, and critical levels can be received as input parameters, where these thresholds or levels can be used to generate communications from the results. The refined borehole operation monitor model can be identified or accessed in a process 510.

There can be more than one model that has been trained and refined, for example, a model can be specifically trained for completion operations, drilling operations, hydraulic fracturing operations, or other types of operations. In some aspects, there can be separate models used for different geological conditions, such as offshore versus onshore. In some aspects, one model can incorporate more than one set of operational activities, for example, combining drilling and hydraulic fracturing operations in one trained model. In some aspects, the borehole operation monitor model can be more than one model, for example, a drilling model and a geological model.

In a process 520, (similar to process 420) the received outputs from the monitoring systems can be analyzed using the borehole operation monitor model. Bracket 535 demonstrates a potential analysis result from the model, similar to bracket 435. Process 540 utilizes the model to identify the best outcomes from the data analyzed. In some aspects, a quantity of best-match outcomes can be identified such as when there is a potential for more than one outcome from the analysis.

Process 520 and process 540 can be part of the same model (e.g., the same machine learning system). In a process 550, the outcomes can be reported as the results from the model processing the input data. The results can be communicated to a user, a reporting system, or a logging system. The results can be communicated using various communication mechanisms now known or later developed. Results can be communicated as messages, such as information and status. Results can be communicated as warnings, such as when the potential for an event for a time interval has exceeded a warning threshold for that event. Results can be communicated as alerts, such as when the potential for and for a time interval has exceeded an alert or critical threshold. Results can be communicated to other borehole systems, such as to be used as input parameters for other processing or used as directions to modify a borehole system operation. For example, the result can be communicated to a pump system to direct the pump system to adjust fluid pressure. Results can be communicated as recommendations for action to be taken. The recommendations can be reviewed and verified before instructions are sent to other borehole systems.

There can be more than one result from the analysis covering one or more boreholes or reservoir operations. For example, a fluid pressure can be predicted to exceed a specified limit over a time interval and the fluid pressure can be predicted to drop over the time interval, depending on other parameters and changes occurring downhole a borehole. These outcomes can be reported as the results to be further reviewed by a user or other borehole systems. In some aspects, more than one result can be reported for non-related systems, for example, a fluid pressure critical change and a bed boundary can be reported. In some aspects, a conflict can be flagged for a user to verify.

FIG. 6 is an illustration of a flow diagram of an example method 600 to train and validate a borehole operation monitor model. Method 600 can be performed on a computing system, for example, borehole operation monitor model system 800 of FIG. 8 or borehole operation monitor model controller 900 of FIG. 9. The computing system can be a well site controller, a reservoir controller, a geo-steering system, a seismic system, a data center, a cloud environment, a server, a laptop, a corporate system, an edge computing system, a mobile device, a smartphone, a PDA, or other computing system capable of receiving the monitoring systems output, input parameters, and capable of communicating with other computing systems. Method 600 can be encapsulated in software code or hardware, for example, an application, code library, dynamic link library, module, function, RAM, ROM, and other software and hardware implementations. The software can be stored in a file, database, or other computing system storage mechanism. Method 600 can be partially implemented in software and partially in hardware. Method 600 can perform the steps for the described processes, for example, using a machine learning system for analyzing the visualizations of outputs of other monitoring systems and tagging the input data with training labels.

Method 600 starts at a step 605 and proceeds to a step 610. In step 610, visualization outputs from monitoring systems can be received. Input parameters can be received, such as to specify warning, alert, or critical thresholds for one or more borehole or reservoir events, or other parameters. A borehole operation monitor model can be selected where the model is initialized or previously trained.

In a step 615, the processes can monitor the output from the monitoring systems over time or over a depth. The output can be received in real-time, near real-time, or be received from a data store, such as historical data (e.g., historical outputs). In a step 620, the received monitor output can be analyzed. For example, an event can be identified, a geological change can be identified, equipment reliability or failure state can be identified, or other types of events can be identified. Training labels can be associated with these events, for example, a change in resistivity responses combined with a change in gamma-ray response at a similar depth in the borehole can be associated with a bed boundary change.

In a step 625, the association of the analyzed data and training labels can be validated, for example, by review of a user. In a step 630, the borehole operation monitor model can be updated with the new training data. Method 600 ends at a step 695.

FIG. 7 is an illustration of a flow diagram of an example method 700 utilizing a borehole operation monitor model. Method 700 can be performed on a computing system, for example, borehole operation monitor model system 800 of FIG. 8 or borehole operation monitor model controller 900 of FIG. 9. Method 700 can be performed on the same system as method 600. The computing system can be a well site controller, a reservoir controller, a borehole controller, a geo-steering system, a data center, a cloud environment, a server, a laptop, a corporate system, an edge computing system, a mobile device, a smartphone, a PDA, or other computing system capable of receiving the monitored outputs, input parameters, and capable of communicating with other computing systems. Method 700 can be encapsulated in software code or in hardware, for example, an application, code library, dynamic link library, module, function, RAM, ROM, and other software and hardware implementations. The software can be stored in a file, database, or other computing system storage mechanism. Method 700 can be partially implemented in software and partially in hardware. Method 700 can perform the steps for the described processes, for example, using a machine learning system for determining a result from other monitoring systems' visualizations.

Method 700 starts at a step 705 and proceeds to a step 710. In step 710, visualization outputs from monitoring systems can be received. Input parameters can be received, such as to specify warning, alert, or critical thresholds for one or more borehole or reservoir events, or other parameters. A borehole operation monitor model can be selected where the model is initialized or previously trained.

In a step 715, the processes can monitor the output from the monitoring systems over time or over a depth. The output can be received in real-time or near real-time. In a step 720, the received monitor output can be analyzed. For example, an event can be identified, a geological change can be identified, equipment reliability or failure state can be identified, or other types of events can be identified. A probability for that event occurring over a specified time interval can be determined for each event. It is possible to generate two results that are partially or wholly contradictory, as the processes determine estimations and probabilities. In some aspects, in scenarios where a conflict or unclear result is generated, a user can validate the result. In some aspects, the result can produce at least two contradictory outcomes, and the contradictory outcomes are communicated with the result to the user for verification.

In a step 725, the results can be used to generate one or more communications. The communications can be generated to be sent (once approved) to one or more target systems, for example, a user, a borehole controller, equipment located at the borehole site, a data center, a cloud environment, or other target systems. Communications can be sent using various communication methods, for example, messages can be communicated using logs, reports, displays, text messages, automated phone calls, emails, or other communication methods. The communications can include information about the result. For example, a message can contain status information or characteristic information, a warning can contain specifics on an event and its probability of occurring over a time interval. Alerts, critical messages, and recommendations can be communicated. In some aspects, the communications can include directions to a controller or borehole equipment to adjust operating parameters. For example, a result can identify that a hole cleaning operation should be scheduled as soon as possible and that information can be communicated to the appropriate borehole equipment to begin a cleaning operation. The automated direction can reduce the time for borehole operations to be modified by downhole conditions thereby improving operation efficiency.

In a step 730, the results can be validated by a user before the communications being sent. In some aspects, the validation can be an optional step for one or more types of results. For example, messaging communications can be sent without validation while warnings and alerts can be reviewed by a user. Method 700 ends at a step 795.

FIG. 8 is an illustration of a block diagram of an example borehole operation monitor model system 800. which can be implemented in one or more computing systems, for example, a data center, a cloud environment, a server, a laptop, a smartphone, a tablet, an edge computing system, a laboratory system, or other computing systems. In some aspects, borehole operation monitor model system 800 can be implemented using a borehole operation monitor model controller such as borehole operation monitor model controller 900 of FIG. 9. Borehole operation monitor model system 800 can implement one or more methods of this disclosure, such as method 600 of FIG. 6 or method 700 of FIG. 7.

Borehole operation monitor model system 800, or a portion thereof, can be implemented as an application, a code library, a dynamic link library, a function, a module, other software implementation, or combinations thereof. In some aspects, borehole operation monitor model system 800 can be implemented in hardware, such as a ROM, a graphics processing unit, or other hardware implementation. In some aspects, borehole operation monitor model system 800 can be implemented partially as a software application and partially as a hardware implementation. Borehole operation monitor model system 800 is a functional view of the disclosed processes and an implementation can combine or separate the described functions in one or more software or hardware systems.

Borehole operation monitor model system 800 includes a data transceiver 810, a borehole operation analyzer 820, and a result transceiver 830. The outputs (e.g., results) from borehole operation analyzer 820 can be communicated to a data receiver, such as one or more of a user or user system 860, a computing system 862, or other processing or storage systems 864. The output can be used to determine changes to a borehole operation, a reservoir operation when replacement parts are ordered or shipped, if emergency actions need to be implemented, or to adjust progress guidance on the development of the borehole or reservoir. The output can be used to send out messages, alerts, warnings, recommendations, or various combinations thereof. The output can be communicated to one or more users, to one or more other borehole systems, to one or more machine learning systems, or various combinations thereof.

Data transceiver 810 can receive input parameters, such as parameters to direct the operation of the analysis implemented by borehole operation analyzer 820, such as the monitoring to use as inputs, thresholds for communicating alerts and warnings, and other control functions and parameters. The input parameters can include the outputs of other borehole monitoring systems, such as visuals, spreadsheets, charts, graphs, or other outputs typically used by users. In some aspects, data transceiver 810 can be part of borehole operation analyzer 820.

Result transceiver 830 can communicate one or more results (e.g., messages, alerts, warnings, recommendations, or directions to other systems), analysis, or interim outputs, to one or more data receivers, such as user or user system 860, computing system 862, storage system 864, e.g., a data store or database, or other related systems, whether located proximate result transceiver 830 or distant from result transceiver 830. In some aspects, the results can be communicated to a user using an alert communication path when the results indicate an alert threshold or a critical threshold is satisfied. In some aspects, the results can be used to inform the user that different equipment or replacement equipment would improve borehole operation efficiency. In some aspects, the outputs can be analyzed using a machine learning system to execute a previously trained borehole operation monitor model to determine parameters for one or more events occurring during the borehole operation.

Data transceiver 810, borehole operation analyzer 820, and result transceiver 830 can be or can include, conventional interfaces configured for transmitting and receiving data. In some aspects, borehole operation analyzer 820 can be a machine learning system or a deep neural network learning system, such as providing a process to parse and analyze the received borehole monitoring systems output.

Borehole operation analyzer 820, such as a borehole analyzer processor, can implement the analysis and algorithms as described herein utilizing the monitoring inputs and other input parameters. For example, borehole operation analyzer 820 can perform the analysis of monitoring system outputs, generate messages, alerts, warnings, and recommendations, and communicate the results to one or more users, or to one or more other borehole systems.

A memory or data storage of borehole operation analyzer 820 can be configured to store the processes and algorithms for directing the operation of borehole operation analyzer 820. Borehole operation analyzer 820 can also include a processor that is configured to operate according to the analysis operations and algorithms disclosed herein and an interface to communicate (transmit and receive) data.

FIG. 9 is an illustration of a block diagram of an example borehole operation monitor model controller 900 according to the principles of the disclosure. Borehole operation monitor model controller 900 can be stored on a single computer or on multiple computers. The various components of borehole operation monitor model controller 900 can communicate via wireless or wired conventional connections. A portion or a whole of borehole operation monitor model controller 900 can be located at one or more locations and other portions of borehole operation monitor model controller 900 can be located on a computing device or devices located at a surface location. In some aspects, borehole operation monitor model controller 900 can be wholly located at a surface or distant location. In some aspects, borehole operation monitor model controller 900 can be part of another system and can be integrated into a single device, such as a part of a borehole operation planning system, a reservoir controller, a corporate system, a data center, a cloud environment, an edge computing system, a well site controller, a geo-steering system, or other borehole systems.

Borehole operation monitor model controller 900 can be configured to perform the various functions disclosed herein including receiving input parameters and outputs of borehole monitoring systems and generating the results from an execution of the methods and processes described herein, such as analyzing the outputs from the monitoring systems and generating messages, alerts, warnings, or recommendations. Borehole operation monitor model controller 900 includes a communications interface 910, a memory 920, and a processor 930.

Communications interface 910 is configured to transmit and receive data. For example, communications interface 910 can receive the input parameters and monitored systems outputs. Communications interface 910 can transmit the results or interim outputs. In some aspects, communications interface 910 can transmit a status, such as a success or failure indicator of borehole operation monitor model controller 900 regarding receiving the various inputs, transmitting the generated results, or producing the result messages or direction to other borehole systems.

In some aspects, a machine learning system can be implemented by processor 930 and perform the operations as described by borehole operation analyzer 820. Communications interface 910 can communicate via communication systems used in the industry. For example, wireless or wired protocols can be used. Communication interface 910 can perform the operations as described for data transceiver 810 and result transceiver 830 of FIG. 8.

Memory 920 can be configured to store a series of operating instructions that direct the operation of processor 930 when initiated, including the code representing the algorithms for determining processing the collected data. Memory 920 is a non-transitory computer readable medium. Multiple types of memory can be used for data storage and memory 920 can be distributed.

Processor 930, such as a borehole analyzer processor, can be configured to produce the results, one or more interim outputs, and statuses utilizing the received inputs. For example, processor 930 can analyze the monitored systems and produce results. Processor 930 can be configured to direct the operation of borehole operation monitor model controller 900. Processor 930 includes the logic to communicate with communications interface 910 and memory 920, and performs the functions described herein. Processor 930 can perform or direct the operations as described by borehole operation analyzer 820 of FIG. 8.

FIG. 10 is an illustration of a diagram of an example analyzation 1000 using two example borehole operation monitors. To identify bed boundaries using the provided gamma ray and resistivity inversion data, the transitions in the gamma-ray and resistivity curves can be analyzed. A bed boundary can be marked by a noticeable change in one or more of these measurements.

Analyzation 1000 includes a gamma ray log 1010 using a measured depth (MD) on an x-axis 1005. Bed boundaries can be indicated where the gamma-ray log shows a sharp change in value. For example, at approximately 7,110 MD, there is a sharp drop in gamma ray values, indicating a transition from a shale-rich formation to a cleaner sandstone or carbonate bed. Another significant change occurs around 7,800 MD, where the gamma-ray values sharply decrease, signaling the presence of a new bed.

Analyzation 1000 includes a resistivity inversion analysis 1030 using an MD on an x-axis 1035. In the resistivity inversion, bed boundaries can be indicated by transitions between high-resistivity (darker areas) and low-resistivity regions (lighter areas). Around 7,000 MD, there is a clear boundary where the resistivity changes from high to low, suggesting a bed boundary. At 7,800 MD, the resistivity inversion shows a transition from low to high resistivity, further confirming a bed boundary.

The disclosed processes, such as using a borehole analyzer processor, the outputs from each of the borehole monitoring systems can be analyzed. Combining both data sets, the system can deduce that bed boundaries can be identified at the following approximate depths: (1) 7,110 MD where the transition from high gamma-ray to low gamma-ray indicates a cleaner formation. (2) 7,300 MD where a noticeable shift in gamma-ray and resistivity values indicate a change in lithology. (3) 7,800 MD where a significant decrease in gamma ray values and a corresponding increase in resistivity, suggests a new bed. These boundaries mark significant changes in the geological layers, likely indicating different rock types or formations.

A portion of the above-described apparatus, systems, or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate array (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that has program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Each of the disclosed aspects in the SUMMARY section can have one or more of the following additional elements in combination. Element 1: wherein the information graphics are one or more of a chart, a graph, a spreadsheet, a two-dimensional model, or a three-dimensional model. Element 2: wherein the one or more outputs are received from a data store, storing historical outputs. Element 3: wherein the borehole operation is one of a drilling operation, a completion operation, a hole cleaning operation, or a hydraulic fracturing operation. Element 4: wherein the parameters for the one or more events are one or more of a probability of an occurrence and a time interval for the occurrence. Element 5: wherein the result is validated by the user prior to the result being communicated. Element 6: modifying directions to a drilling controller using the result to reduce a probability of the one or more events occurring by adjusting a drilling operation. Element 7: informing the user that different equipment or replacement equipment would improve borehole operation efficiency. Element 8: directing modifications to a drilling controller to adjust a planned borehole path, a composition of drilling mud, or repairs of a casing using the result. Element 9: wherein the input parameters include an alert threshold, a warning threshold, and a critical threshold for one or more of the one or more events. Element 10: wherein the result produces at least two contradictory outcomes, and the contradictory outcomes are communicated with the results to the user for verification. Element 11: wherein the borehole operation monitor model system is located as part of a well site controller. Element 12: wherein the borehole monitoring systems are located in a same borehole controller as the borehole operation monitor model system. Element 13: wherein the result is directions to a drilling controller to adjust a current drilling operation. Element 14: wherein the result is communicated to a user using an alert communication path when the results indicate an alert threshold or a critical threshold is satisfied. Element 15: wherein the borehole operation monitor model system is more than one model, including at least a geological model and a drilling model. Element 16: wherein the borehole operation monitor model system analyzes more than one borehole during a same execution time interval. Element 17: wherein the at least one information graphic is a visual representation of one or more of a well log curve, a plot, a drilling information graphic, a geology model mapping, or a resistivity inversion image. Element 18: modifying directions to a drilling controller using the result to reduce a probability of the one or more events occurring by adjusting a drilling operation.

1. A method, comprising:
receiving input parameters and receiving one or more outputs from borehole monitoring systems monitoring a borehole operation at a borehole, wherein the one or more outputs are information graphics generated from data collected from sensors located at a surface location of the borehole and from sensors located downhole the borehole;
analyzing the one or more outputs using a machine learning system to initialize or refine a borehole operation monitor model, wherein the machine learning system uses the information graphics to identify analyzed events, through applying one or more thresholds, for which messaging is to be produced;
applying, using the machine learning system, training labels to a result of the analyzing, wherein the training labels correspond to the analyzed events;
validating the training labels by a user;
updating the borehole operation monitor model using the training labels; and
modifying, automatically, a borehole operation analyzer with the borehole operation monitor model, where the borehole operation analyzer is configured to monitor borehole operations at a borehole site.

2. The method as recited in claim 1, wherein the information graphics are one or more of a chart, a graph, a spreadsheet, a two-dimensional model, or a three-dimensional model.

3. The method as recited in claim 1, wherein the one or more outputs are received from a data store, storing historical outputs.

4. A method, comprising:
receiving input parameters and receiving one or more outputs from borehole monitoring systems, wherein the one or more outputs are information graphics and the borehole monitoring systems produce the one or more outputs from data collected from one or more sensors located downhole a borehole and at a surface of the borehole while the borehole is undergoing a borehole operation;
analyzing the one or more outputs using a machine learning system to execute a previously trained borehole operation monitor model to determine parameters for one or more events occurring during the borehole operation, wherein the machine learning system previously trained the borehole operation monitor model using previously received information graphics received from other monitoring systems;
modifying, automatically, a borehole operation analyzer with an output from the analyzing, where the borehole operation analyzer is monitoring the borehole operation;
generating a result from the borehole operation analyzer, wherein the result is one of a message, a warning, an alert, or a recommendation, and the parameters of the one or more events; and
communicating the result to a user or a borehole system.

5. The method as recited in claim 4, wherein the borehole operation is one of a drilling operation, a completion operation, a hole cleaning operation, or a hydraulic fracturing operation.

6. The method as recited in claim 4, wherein the parameters for the one or more events are one or more of a probability of an occurrence and a time interval for the occurrence.

7. The method as recited in claim 4, wherein the result is validated by the user prior to the result being communicated.

8. The method as recited in claim 4, further comprising:
modifying directions to a drilling controller using the result to reduce a probability of the one or more events occurring by adjusting a drilling operation.

9. The method as recited in claim 4, further comprising
informing the user that different equipment or replacement equipment would improve borehole operation efficiency.

10. The method as recited in claim 4,
directing modifications to a drilling controller to adjust a planned borehole path, a composition of drilling mud, or repairs of a casing using the result.

11. The method as recited in claim 4, wherein the input parameters include an alert threshold, a warning threshold, and a critical threshold for one or more of the one or more events.

12. The method as recited in claim 4, wherein the result is a first result, and further comprising:
generating a second result from the analyzing, wherein the second result uses analyzing with a different set of estimations or probabilities than the analyzing for the first result, the first result and the second result contradict each other, and the first result and the second result are communicated to the user for verification.

13. A borehole operation monitor model system, comprising:
a data transceiver, capable of receiving input parameters and receiving outputs from at least one information graphic from one or more borehole monitoring systems, wherein the borehole monitoring systems receive input from one and more sensors located at a surface of a borehole or located downhole the borehole;
a borehole operation monitor model, as implemented using machine learning system, capable of communicating with the data transceiver and analyzing, using one or more thresholds, the outputs from the at least one information graphic for one or more events of a borehole operation being performed at the borehole; and
a borehole operation analyzer, automatically updated using the borehole operation monitor model, configured to determine one or more parameters for the one or more events including a probability of occurrence over a specified time interval, and generating a result to be communicated, wherein the result is a message, warning, alert, or recommendation.

14. The borehole operation monitor model system as recited in claim 13, wherein the borehole operation monitor model system is located as part of a well site controller.

15. The borehole operation monitor model system as recited in claim 13, wherein the borehole monitoring systems are located in a same borehole controller as the borehole operation monitor model system.

16. The borehole operation monitor model system as recited in claim 13, wherein the result is directions to a drilling controller to adjust a current drilling operation.

17. The borehole operation monitor model system as recited in Claim 13, wherein the result is communicated to a user using an alert communication path when the results indicate an alert threshold or a critical threshold is satisfied, where the alert threshold is satisfied when a priority is identified to be addressed, and the critical threshold is satisfied when the probability of occurrence over the specified time interval satisfies the critical threshold.

18. The borehole operation monitor model system as recited in claim 13, wherein the borehole operation monitor model system is more than one model, including at least a geological model and a drilling model.

19. The borehole operation monitor model system as recited in claim 13, wherein the borehole operation monitor model system analyzes more than one borehole during a same execution time interval.

20. The borehole operation monitor model system as recited in claim 13, wherein the at least one information graphic is a visual representation of one or more of a well log curve, a plot, a drilling information graphic, a geology model mapping, or a resistivity inversion image.

21. A non-transitory computer program product having a series of operating instructions stored on a non-transitory computer-readable medium that directs operations, the operations comprising:
receiving input parameters and receiving one or more outputs from borehole monitoring systems, wherein the one or more outputs are information graphics and the borehole monitoring systems produce the one or more outputs from data collected from one or more sensors located downhole a borehole and at a surface of the borehole while the borehole is undergoing a borehole operation;
analyzing the one or more outputs using a machine learning system to execute a previously trained borehole operation monitor model to determine parameters for one or more events occurring during the borehole operation, wherein the machine learning system uses the information graphics to identify analyzed events, through applying one or more thresholds, for which messaging is to be produced;
modifying, automatically, a borehole operation analyzer with an output from the analyzing, where the borehole operation analyzer is monitoring the borehole operation;
generating a result from the borehole operation analyzer, wherein the result is one of a message, a warning, an alert, or a recommendation, and parameters of the one or more events; and
communicating the result to a user or a borehole system.

22. The non-transitory computer program product as recited in claim 21, further comprising:
modifying directions to a drilling controller using the result to reduce a probability of the one or more events occurring by adjusting a drilling operation.
